(19) United States
(12) Patent Application Publication
(10) Pub. No.: US 2026/0231225 A1
(43) Pub. Date: Aug. 6, 2026

(54) PHYSICAL RANDOM ACCESS CHANNEL COMMUNICATIONS SCHEDULED FOR A CANDIDATE CELL

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US)

(21) Appl. No.: 19/151,435

(22) PCT Filed: Apr. 3, 2023
(86) PCT No.: PCT/CN2023/085855

§ 371 Date: Jul. 28, 2025

(51) Int. Cl. H04W 74/0833; H04W 76/15

(52) U.S. Cl. CPC H04W 74/0833; H04W 76/15

(57) ABSTRACT

Various aspects of the present disclosure generally relate to wireless communication. In some aspects, a user equipment (UE) may receive, via a serving cell, an indication to transmit a physical random access channel (PRACH) communication to a candidate cell. The UE may transmit the PRACH communication with an offset from reception of the indication to transmit the PRACH communication, the offset based at least in part on one or more of: whether the UE previously identified the candidate cell, one or more characteristics of a random access channel (RACH) associated with the candidate cell, or one or more capabilities of the UE. Numerous other aspects are described.

### FIELD OF THE DISCLOSURE

Aspects of the present disclosure generally relate to wireless communication and to techniques and apparatuses for physical random access channel communications scheduled for a candidate cell.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, via a serving cell, an indication to transmit a physical random access channel (PRACH) communication to a candidate cell. The method may include transmitting the PRACH communication with an offset from reception of the indication to transmit the PRACH communication, the offset based at least in part on one or more of whether the UE previously identified the candidate cell, one or more characteristics of a random access channel (RACH) associated with the candidate cell, or one or more capabilities of the UE.

Some aspects described herein relate to a method of wireless communication performed by a UE. The method may include transmitting a PRACH communication to a candidate cell based at least in part on reception of an indication to transmit the PRACH communication from a serving cell. The method may include receiving a response message, associated with the PRACH communication, with an offset from transmission of the PRACH communication, the offset based at least in part on one or more of a fixed duration, or one or more capabilities of the UE.

Some aspects described herein relate to a method of wireless communication performed by a network node. The method may include transmitting, via a serving cell and to a UE, an indication to transmit a PRACH communication to a candidate cell. The method may include receiving the PRACH communication with an offset from transmission of the indication to transmit the PRACH communication, the offset based at least in part on one or more of whether the UE previously identified the candidate cell, one or more characteristics of a RACH associated with the candidate cell, or one or more capabilities of the UE.

Some aspects described herein relate to a method of wireless communication performed by a network node. The method may include receiving a PRACH communication, from a UE and via a candidate cell, based at least in part on transmission of an indication to transmit the PRACH communication from a serving cell. The method may include transmitting a response message, associated with the PRACH communication, with an offset from transmission of the PRACH communication, the offset based at least in part on one or more of a fixed duration, or one or more capabilities of the UE.

Some aspects described herein relate to a UE for wireless communication. The UE may include a memory and one or more processors coupled to the memory. The one or more processors may be configured to receive, via a serving cell, an indication to transmit a PRACH communication to a candidate cell. The one or more processors may be configured to transmit the PRACH communication with an offset from reception of the indication to transmit the PRACH communication, the offset based at least in part on one or more of whether the UE previously identified the candidate cell, one or more characteristics of a RACH associated with the candidate cell, or one or more capabilities of the UE.

Some aspects described herein relate to a UE for wireless communication. The UE may include a memory and one or more processors coupled to the memory. The one or more processors may be configured to transmit a PRACH communication to a candidate cell based at least in part on reception of an indication to transmit the PRACH communication from a serving cell. The one or more processors may be configured to receive a response message, associated with the PRACH communication, with an offset from transmission of the PRACH communication, the offset based at least in part on one or more of a fixed duration, or one or more capabilities of the UE.

Some aspects described herein relate to a network node for wireless communication. The network node may include a memory and one or more processors coupled to the memory. The one or more processors may be configured to transmit, via a serving cell and to a UE, an indication to transmit a PRACH communication to a candidate cell. The one or more processors may be configured to receive the PRACH communication with an offset from transmission of the indication to transmit the PRACH communication, the offset based at least in part on one or more of whether the UE previously identified the candidate cell, one or more characteristics of a RACH associated with the candidate cell, or one or more capabilities of the UE.

Some aspects described herein relate to a network node for wireless communication. The network node may include a memory and one or more processors coupled to the memory. The one or more processors may be configured to receive a PRACH communication, from a UE and via a candidate cell, based at least in part on transmission of an indication to transmit the PRACH communication from a serving cell. The one or more processors may be configured to transmit a response message, associated with the PRACH communication, with an offset from transmission of the PRACH communication, the offset based at least in part on one or more of a fixed duration, or one or more capabilities of the UE.

Some aspects described herein relate to a non-transitory computer-readable medium that stores a set of instructions for wireless communication by a UE. The set of instructions, when executed by one or more processors of the UE, may cause the UE to receive, via a serving cell, an indication to transmit a PRACH communication to a candidate cell. The set of instructions, when executed by one or more processors of the UE, may cause the UE to transmit the PRACH communication with an offset from reception of the indication to transmit the PRACH communication, the offset based at least in part on one or more of whether the UE previously identified the candidate cell, one or more characteristics of a RACH associated with the candidate cell, or one or more capabilities of the UE.

Some aspects described herein relate to a non-transitory computer-readable medium that stores a set of instructions for wireless communication by a UE. The set of instructions, when executed by one or more processors of the UE, may cause the UE to transmit a PRACH communication to a candidate cell based at least in part on reception of an indication to transmit the PRACH communication from a serving cell. The set of instructions, when executed by one or more processors of the UE, may cause the UE to receive a response message, associated with the PRACH communication, with an offset from transmission of the PRACH communication, the offset based at least in part on one or more of a fixed duration, or one or more capabilities of the UE.

Some aspects described herein relate to a non-transitory computer-readable medium that stores a set of instructions for wireless communication by a network node. The set of instructions, when executed by one or more processors of the network node, may cause the network node to transmit, via a serving cell and to a UE, an indication to transmit a PRACH communication to a candidate cell. The set of instructions, when executed by one or more processors of the network node, may cause the network node to receive the PRACH communication with an offset from transmission of the indication to transmit the PRACH communication, the offset based at least in part on one or more of whether the UE previously identified the candidate cell, one or more characteristics of a RACH associated with the candidate cell, or one or more capabilities of the UE.

Some aspects described herein relate to a non-transitory computer-readable medium that stores a set of instructions for wireless communication by a network node. The set of instructions, when executed by one or more processors of the network node, may cause the network node to receive a PRACH communication, from a UE and via a candidate cell, based at least in part on transmission of an indication to transmit the PRACH communication from a serving cell. The set of instructions, when executed by one or more processors of the network node, may cause the network node to transmit a response message, associated with the PRACH communication, with an offset from transmission of the PRACH communication, the offset based at least in part on one or more of a fixed duration, or one or more capabilities of the UE.

Some aspects described herein relate to an apparatus for wireless communication. The apparatus may include means for receiving, via a serving cell, an indication to transmit a PRACH communication to a candidate cell. The apparatus may include means for transmitting the PRACH communication with an offset from reception of the indication to transmit the PRACH communication, the offset based at least in part on one or more of whether the apparatus previously identified the candidate cell, one or more characteristics of a RACH associated with the candidate cell, or one or more capabilities of the apparatus.

Some aspects described herein relate to an apparatus for wireless communication. The apparatus may include means for transmitting a PRACH communication to a candidate cell based at least in part on reception of an indication to transmit the PRACH communication from a serving cell. The apparatus may include means for receiving a response message, associated with the PRACH communication, with an offset from transmission of the PRACH communication, the offset based at least in part on one or more of a fixed duration, or one or more capabilities of the apparatus.

Some aspects described herein relate to an apparatus for wireless communication. The apparatus may include means for transmitting, via a serving cell and to a UE, an indication to transmit a PRACH communication to a candidate cell.

The apparatus may include means for receiving the PRACH communication with an offset from transmission of the indication to transmit the PRACH communication, the offset based at least in part on one or more of whether the UE previously identified the candidate cell, one or more characteristics of a RACH associated with the candidate cell, or one or more capabilities of the UE.

Some aspects described herein relate to an apparatus for wireless communication. The apparatus may include means for receiving a PRACH communication, from a UE and via a candidate cell, based at least in part on transmission of an indication to transmit the PRACH communication from a serving cell. The apparatus may include means for transmitting a response message, associated with the PRACH communication, with an offset from transmission of the PRACH communication, the offset based at least in part on one or more of a fixed duration, or one or more capabilities of the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of make-before-break handover, in accordance with the present disclosure.

FIG. 5 is a diagram illustrating an example of UE mobility, in accordance with the present disclosure.

FIG. 6 is a diagram illustrating an example of a four-step random access procedure, in accordance with the present disclosure.

FIG. 7 is a diagram illustrating an example of a two-step random access procedure, in accordance with the present disclosure.

FIG. 8 is a diagram of an example associated with physical random access channel (PRACH) communications scheduled for a candidate cell, in accordance with the present disclosure.

FIG. 9 is a diagram of an example associated with receiving a physical downlink control channel (PDCCH) order to transmit a PRACH communication before cell switching, in accordance with the present disclosure.

FIG. 10 is a diagram of an example associated with receiving a PDCCH order to transmit a PRACH communication before cell switching, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram illustrating an example process performed, for example, by a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

A handover procedure may allow a user equipment (UE) to move from a first cell to a second cell based at least in part on layer 1 and/or layer 2 (L1/L2) measurements. However, during a switching time when switching from the first cell to the second cell, communications with the UE may be delayed and/or disrupted. This may cause communication errors, skipping in a stream of data, and/or a loss of an application layer connection, among other examples.

In some aspects described herein, a UE may support transmission of a physical random access channel (PRACH) communication associated with a candidate cell before receiving a cell switching command. In this way, the UE may reduce an amount of time of the cell switching during which communications are interrupted. The UE may reduce communication errors, reduce or avoid skipping in a stream of data, and/or decrease a likelihood of a loss of an application layer connection based at least in part on reducing the amount of time of the cell switching.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

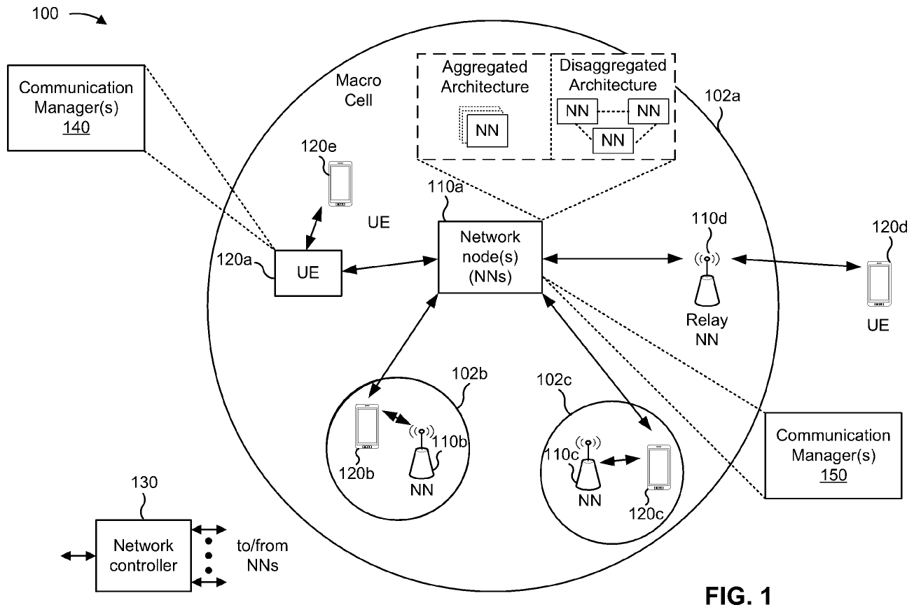

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, via a serving cell, an indication to transmit a PRACH communication to a candidate cell; and transmit the PRACH communication with an offset from reception of the indication to transmit the PRACH communication, the offset based at least in part on one or more of: whether the UE previously identified the candidate cell, one or more characteristics of a random access channel (RACH) associated with the candidate cell, or one or more capabilities of the UE. In some aspects, as described in more detail elsewhere herein, the communication manager 140 may transmit a PRACH communication to a candidate cell based at least in part on reception of an indication to transmit the PRACH communication from a serving cell; and receive a response message, associated with the PRACH communication, with an offset from transmission of the PRACH communication, the offset based at least in part on one or more of: a fixed duration, or one or more capabilities of the UE. Additionally, or alternatively, the communication manager 140 may perform one or more other operations described herein.

In some aspects, the network node 110 may include a communication manager 150. As described in more detail elsewhere herein, the communication manager 150 may transmit, via a serving cell and to a UE, an indication to transmit a PRACH communication to a candidate cell; and receive the PRACH communication with an offset from transmission of the indication to transmit the PRACH communication, the offset based at least in part on one or more of: whether the UE previously identified the candidate cell, one or more characteristics of a RACH associated with the candidate cell, or one or more capabilities of the UE. In some aspects, as described in more detail elsewhere herein, the communication manager 150 may receive a PRACH communication, from a UE and via a candidate cell, based at least in part on transmission of an indication to transmit the PRACH communication from a serving cell; and transmit a response message, associated with the PRACH communication, with an offset from transmission of the PRACH communication, the offset based at least in part on one or more of: a fixed duration, or one or more capabilities of the UE. Additionally, or alternatively, the communication manager 150 may perform one or more other operations described herein.

As indicated above, FIG. 1 is provided as an example. Other examples may differ from what is described with regard to FIG. 1.

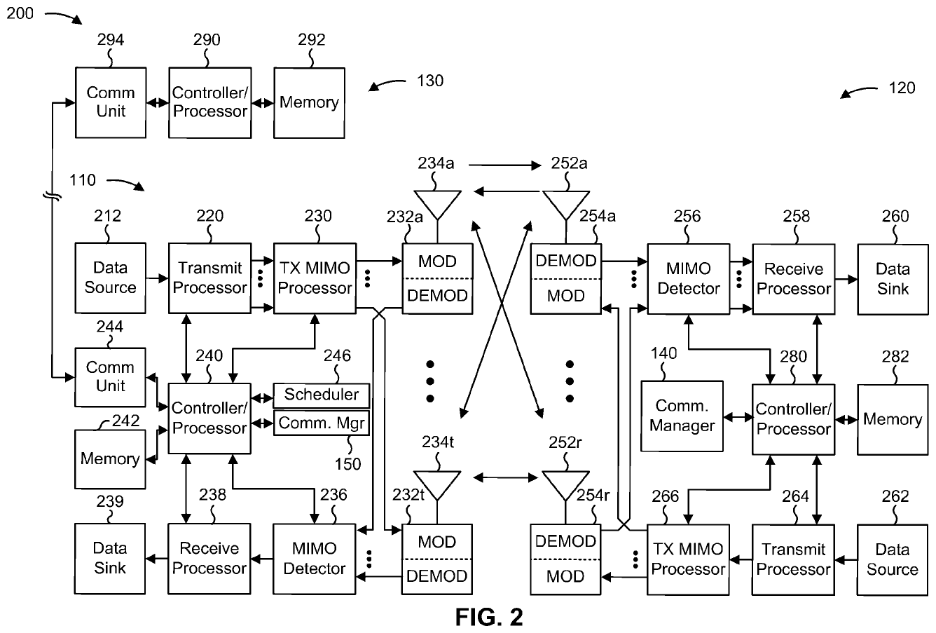

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

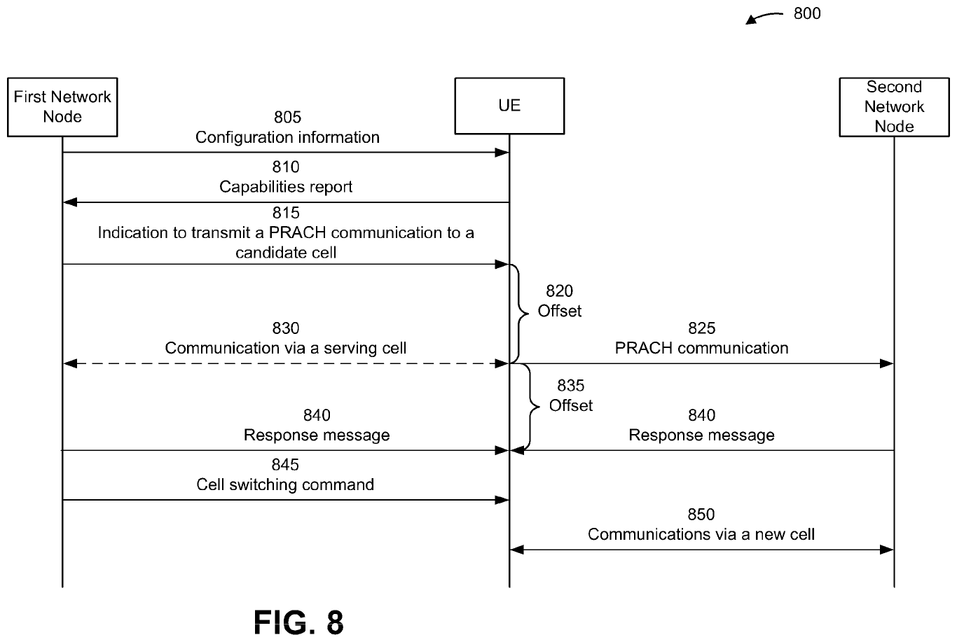

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-16).

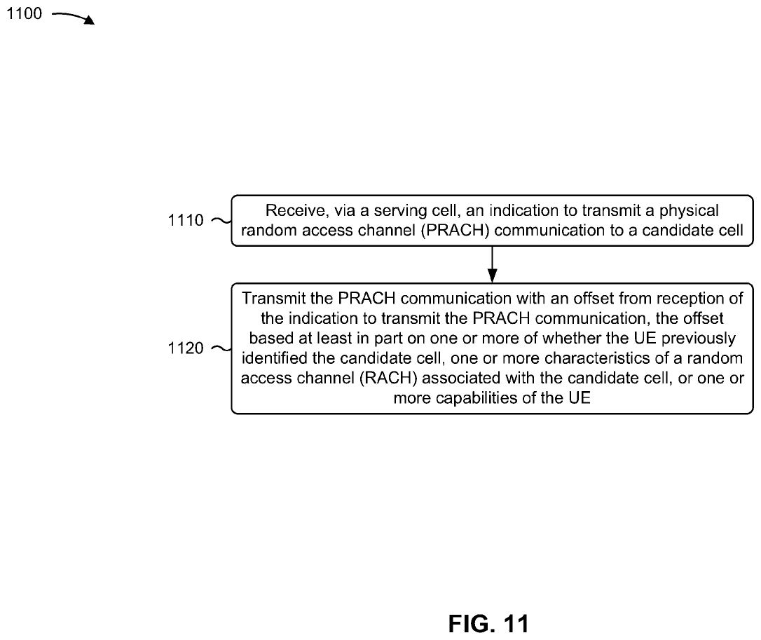

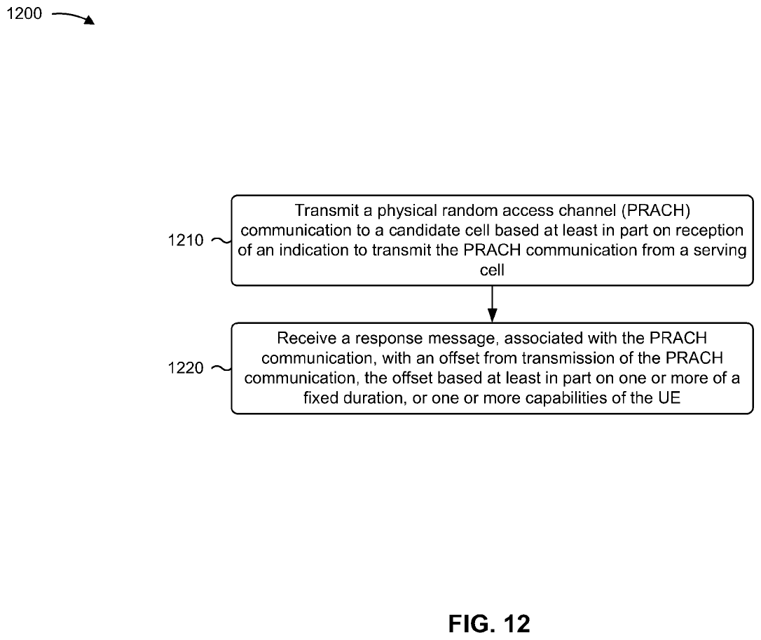

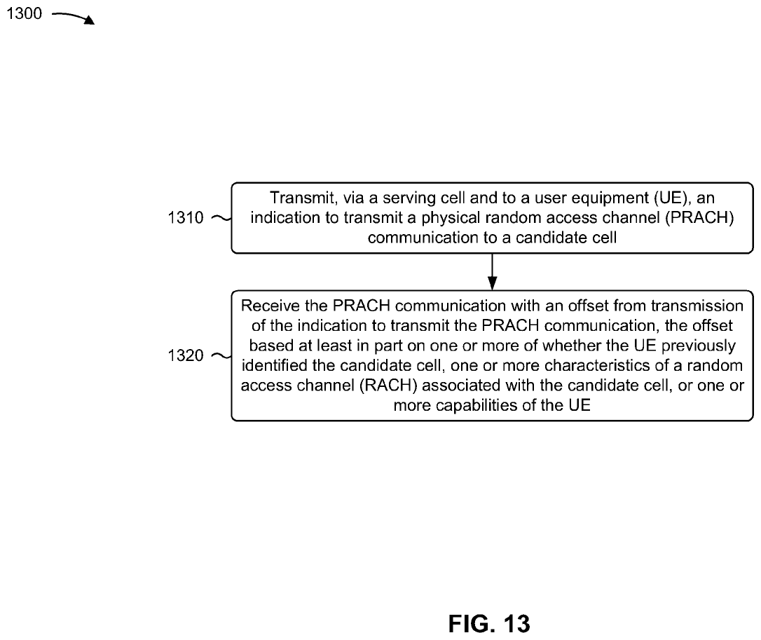

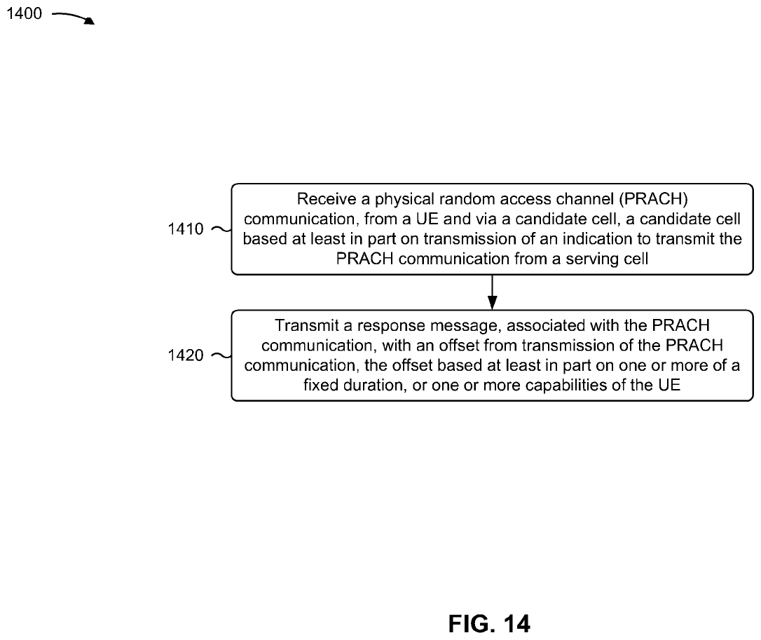

The controller/processor 240 of the network node 110, the controller/processor 280 of the UE 120, and/or any other component(s) of FIG. 2 may perform one or more techniques associated with PRACH communications scheduled for a candidate cell, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE (e.g., the UE 120) includes means for receiving, via a serving cell, an indication to transmit a PRACH communication to a candidate cell; and/or means for transmitting the PRACH communication with an offset from reception of the indication to transmit the PRACH communication, the offset based at least in part on one or more of: whether the UE previously identified the candidate cell, one or more characteristics of a RACH associated with the candidate cell, or one or more capabilities of the UE. In some aspects, the UE (e.g., the UE 120) includes means for transmitting a PRACH communication to a candidate cell based at least in part on reception of an indication to transmit the PRACH communication from a serving cell; and/or means for receiving a response message, associated with the PRACH communication, with an offset from transmission of the PRACH communication, the offset based at least in part on one or more of: a fixed duration, or one or more capabilities of the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node (e.g., the network node 110) includes means for transmitting, via a serving cell and to a UE, an indication to transmit a PRACH communication to a candidate cell; and/or means for receiving the PRACH communication with an offset from transmission of the indication to transmit the PRACH communication, the offset based at least in part on one or more of: whether the UE previously identified the candidate cell, one or more characteristics of a RACH associated with the candidate cell, or one or more capabilities of the UE. In some aspects, the network node (e.g., the network node 110) includes means for receiving a PRACH communication, from a UE and via a candidate cell, based at least in part on transmission of an indication to transmit the PRACH communication from a serving cell; and/or means for transmitting a response message, associated with the PRACH communication, with an offset from transmission of the PRACH communication, the offset based at least in part on one or more of: a fixed duration, or one or more capabilities of the UE. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

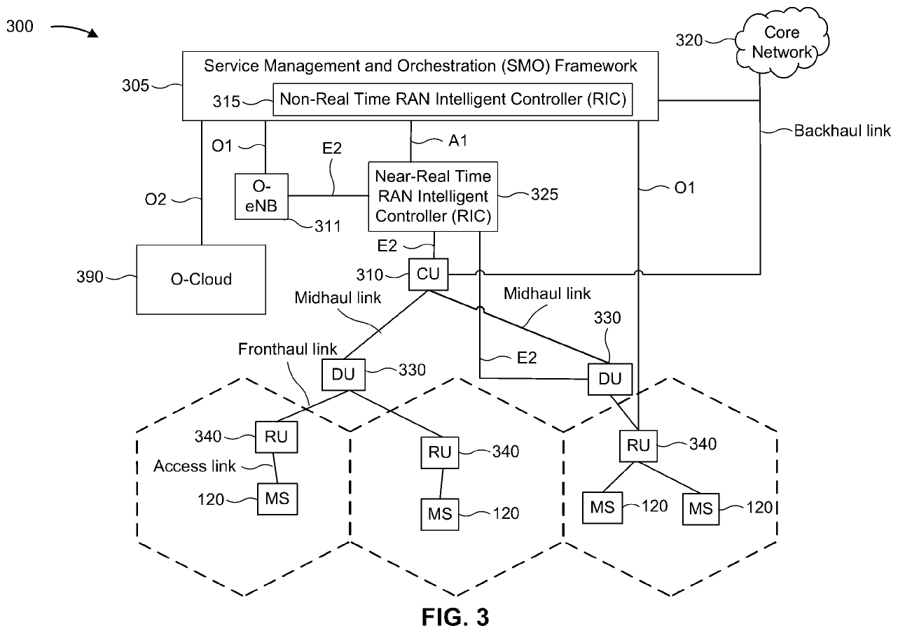

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

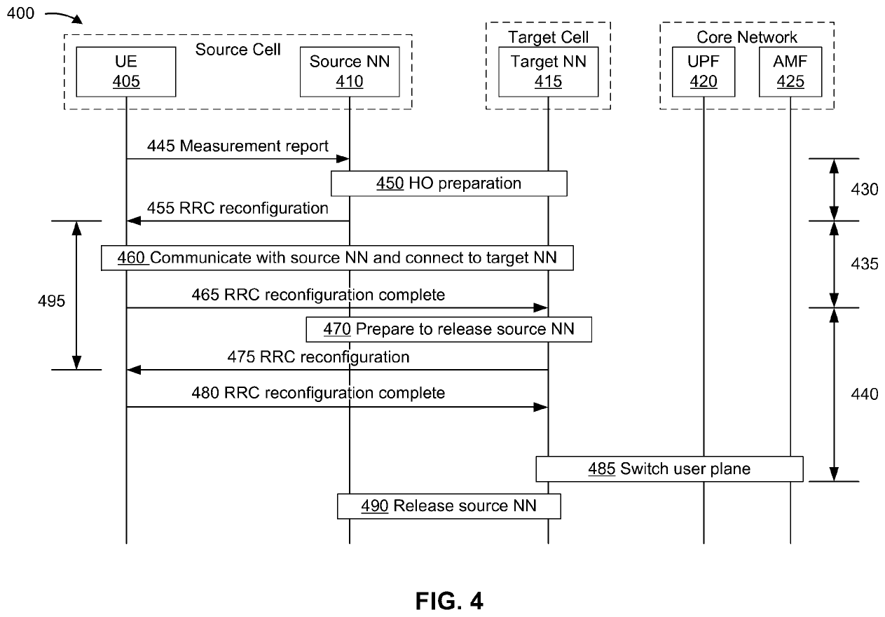

FIG. 4 is a diagram illustrating an example 400 of make-before-break handover, in accordance with the present disclosure.

As shown in FIG. 4, a make-before-break (MBB) handover procedure may involve a UE 405, a source network node 410, a target network node 415, a user plane function (UPF) device 420, and an access and mobility management function (AMF) device 425. In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 405 may correspond to the UE 120 described elsewhere herein. The source network node 410 and/or the target network node 415 may correspond to the network node 110 described elsewhere herein. The UPF device 420 and/or the AMF device 425 may correspond to the network controller 130 described elsewhere herein. The UE 405 and the source network node 410 may be connected (e.g., may have a RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions. The MBB handover procedure may include an enhanced MBB (eMBB) handover procedure.

As shown, the MBB handover procedure may include a handover preparation phase 430, a handover execution phase 435, and a handover completion phase 440. During the handover preparation phase 430, the UE 405 may report measurements that cause the source network node 410 and/or the target network node 415 to prepare for handover and trigger execution of the handover. During the handover execution phase 435, the UE 405 may execute the handover by performing a random access procedure with the target network node 415 and establishing an RRC connection with the target network node 415. During the handover completion phase 440, the source network node 410 may forward stored communications associated with the UE 405 to the target network node 415, and the UE 405 may be released from a connection with the source network node 410.

As shown by reference number 445, the UE 405 may perform one or more measurements, and may transmit a measurement report to the source network node 410 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, then the source network node 410 may trigger a handover of the UE 405 to the target network node 415.

As shown by reference number 450, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an acknowledgement (ACK) to the source network node 410 in response to the handover request.

As shown by reference number 455, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a RACH preamble assignment for accessing the target network node 415. Reception of the RRC reconfiguration message, including the handover command, by the UE 405 may trigger the start of the handover execution phase 435.

As shown by reference number 460, during the handover execution phase 435 of the MBB handover, the UE 405 may execute the handover by performing a random access procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., a sounding reference signal) to the source network node 410, and/or may receive downlink data, downlink control information, and/or a downlink reference signal from the source network node 410.

As shown by reference number 465, upon successfully establishing a connection with the target network node 415 (e.g., via a random access procedure), the UE may transmit an RRC reconfiguration completion message to the target network node 415. Reception of the RRC reconfiguration completion message by the target network node 415 may trigger the start of the handover completion phase 440.

As shown by reference number 470, the source network node 410 and the target network node 415 may communicate with one another to prepare for release of the connection between the source network node 410 and the UE 405. In some aspects, the target network node 415 may determine that a connection between the source network node 410 and the UE 405 is to be released, such as after receiving the RRC reconfiguration completion message from the UE 405. In this case, the target network node 415 may transmit a handover connection setup completion message to the source network node 410. The handover connection setup completion message may cause the source network node 410 to stop transmitting data to the UE 405 and/or to stop receiving data from the UE 405. Additionally, or alternatively, the handover connection setup completion message may cause the source network node 410 to forward communications associated with the UE 405 to the target network node 415 and/or to notify the target network node 415 of a status of one or more communications with the UE 405. For example, the source network node 410 may forward, to the target network node 415, buffered downlink communications (e.g., downlink data) for the UE 405 and/or uplink communications (e.g., uplink data) received from the UE 405. Additionally, or alternatively, the source network node 410 may notify the target network node 415 regarding a PDCP status associated with the UE 405 and/or a sequence number to be used for a downlink communication with the UE 405.

As shown by reference number 475, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, the UE may transmit an RRC reconfiguration completion message to the target network node 415 to indicate that the connection between the source network node 410 and the UE 405 is being released or has been released.

As shown by reference number 485, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the MBB handover procedure, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

As indicated above, FIG. 4 is provided as an example. Other examples may differ from what is described with respect to FIG. 4.

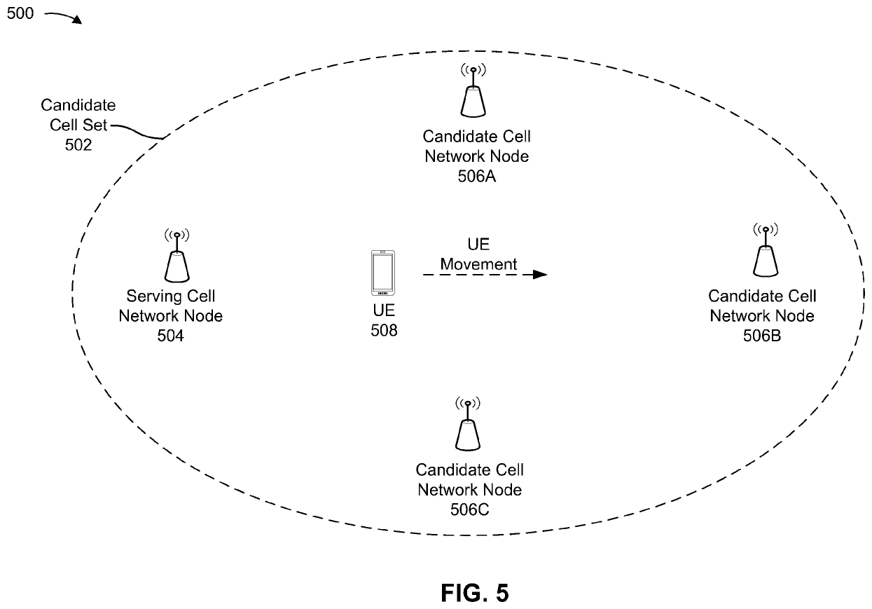

FIG. 5 is a diagram illustrating an example 500 of UE mobility, in accordance with the present disclosure. As shown in FIG. 5, a network may include a candidate cell set 502 that includes cells provided by a serving cell network node 504 (e.g., a serving cell) and a set of candidate cells provided by a set of candidate cell network nodes 506A, 506B, and 506C.

A UE 508 is located within coverage of the candidate cell set 502 and is in communication with the serving cell network node 504. While in communication with the serving cell network node 504, UE movement away from the serving cell network node 504 may cause the UE 508 to have reduced signal strength and/or capacity via the serving cell and may cause the UE 508 to have increased signal strength and/or capacity via a candidate cell, such as a candidate cell associated with the candidate cell network node 506B.

In some networks, a special cell (SpCell) for the UE may be updated via L1/L2 signaling based at least in part on L1 measurement of the serving cell and the candidate cell. In some networks, UE mobility (e.g., moving from one cell to another cell) may include intra-frequency and inter-frequency mobility.

As indicated above, FIG. 5 is provided as an example. Other examples may differ from what is described with respect to FIG. 5.

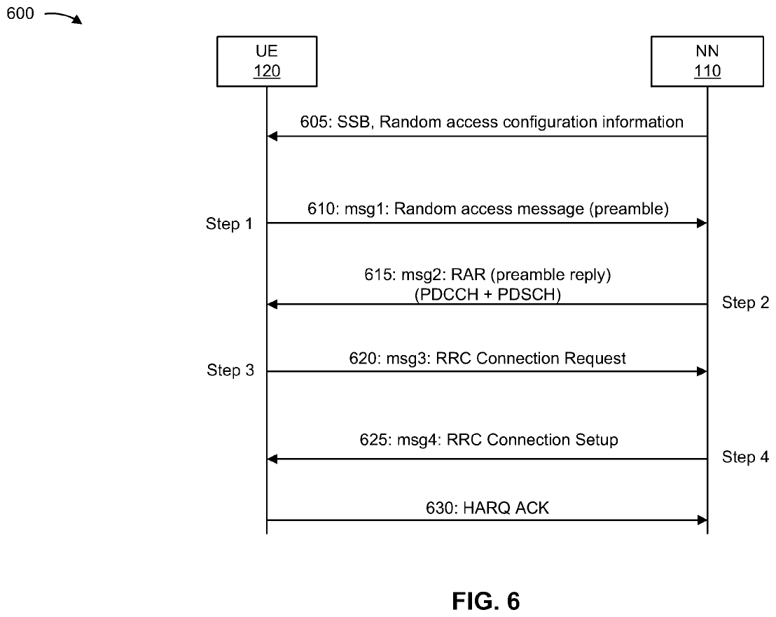

FIG. 6 is a diagram illustrating an example 600 of a four-step random access procedure, in accordance with the present disclosure. As shown in FIG. 6, a network node 110 and a UE 120 may communicate with one another to perform the four-step random access procedure.

As shown by reference number 605, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a RRC message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 610, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 615, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 620, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 625, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 630, if the UE 120 successfully receives the RRC connection setup message, the UE 120 may transmit a HARQ ACK.

As indicated above, FIG. 6 is provided as an example. Other examples may differ from what is described with regard to FIG. 6.

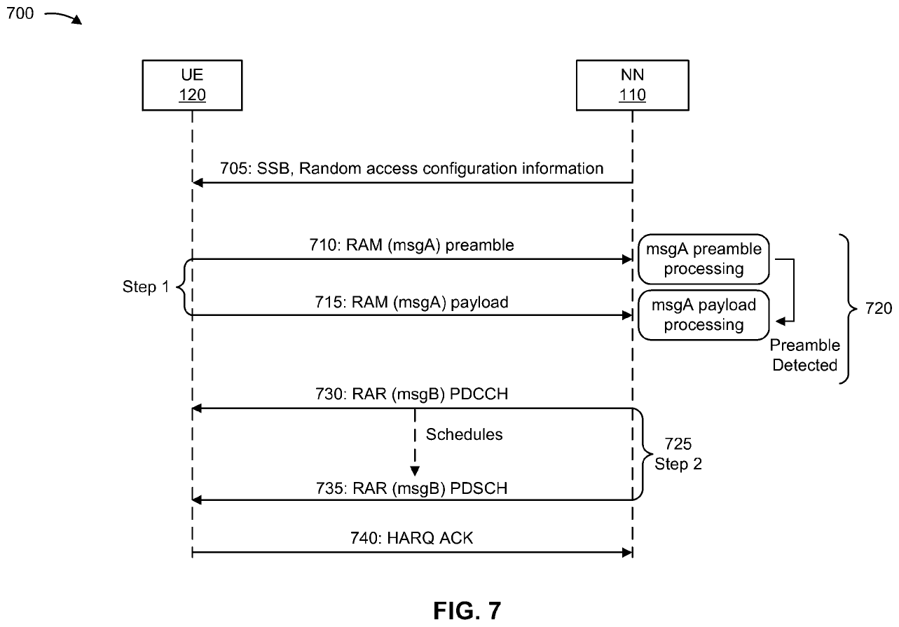

FIG. 7 is a diagram illustrating an example 700 of a two-step random access procedure, in accordance with the present disclosure. As shown in FIG. 7, a network node 110 and a UE 120 may communicate with one another to perform the two-step random access procedure.

As shown by reference number 705, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in a RRC message and/or a PDCCH order message that triggers a RACH procedure, such as for contention-free random access. The random access configuration information may include one or more parameters to be used in the two-step random access procedure, such as one or more parameters for transmitting a RAM and/or receiving an RAR to the RAM.

As shown by reference number 710, the UE 120 may transmit, and the network node 110 may receive, a RAM preamble. As shown by reference number 715, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of the four-step random access procedure, which is described above in connection with FIG. 6. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 720, the network node 110 may receive the RAM preamble transmitted by the UE 120. If the network node 110 successfully receives and decodes the RAM preamble, the network node 110 may then receive and decode the RAM payload.

As shown by reference number 725, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of the four-step random access procedure. For example, the RAR message may include the detected PRACH preamble identifier, the detected UE identifier, a timing advance value, and/or contention resolution information.

As shown by reference number 730, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 735, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 740, if the UE 120 successfully receives the RAR, the UE 120 may transmit a hybrid automatic repeat request (HARQ) ACK.

As indicated above, FIG. 7 is provided as an example. Other examples may differ from what is described with regard to FIG. 7.

As described in connection with FIGS. 4 and 5, a handover procedure may allow a UE to move from a serving cell to a candidate cell (e.g., a target cell). As part of a switching procedure from the serving cell to the candidate cell, the UE may perform a RACH procedure, as described in connection with FIGS. 6 and 7, to establish a connection with the candidate cell. However, during a switching time when switching from the first cell to the second cell, including time used to perform the RACH procedure, communications with the UE may be delayed and/or disrupted. This may cause communication errors, skipping in a stream of data, and/or a loss of an application layer connection, among other examples.

In some aspects described herein, a UE may support transmission of a PRACH communication associated with a candidate cell before receiving a cell switching command. In this way, the UE may reduce an amount of time of the cell switching during which communications are interrupted. The UE may reduce communication errors, reduce or avoid skipping in a stream of data, and/or decrease a likelihood of a loss of an application layer connection based at least in part on reducing the amount of time of the cell switching.

In some aspects described herein, a UE may be triggered (e.g., by an indication from a network node associated with a serving cell) to transmit a PRACH communication to a candidate cell by a PDCCH order in a serving cell. The UE may transmit the PRACH communication with a preamble and during a RACH occasion as indicated by the network node associated with the serving cell. In some aspects, the UE may transmit the PRACH communication at a time that is at least X ms or X symbols after the PDCCH order, where X is a configured threshold.

In some aspects, a value of X may be based at least in part on whether the candidate cell is known. If the candidate cell is unknown, the value may include time for searching for the candidate cell. For example, Tᵢₙₜₑᵣᵣᵤₚₜ=T_{search}+T_{Δ}+T_{margin} MS, where T_{search} is an amount of time used to search for the candidate cell when the UE receives the handover command. If the candidate cell is a known cell, then T_{search}=0 ms. If the candidate cell is an unknown inter-frequency cell and the candidate cell has a measurement metric better than a threshold (e.g., the detected signal energy Es/Iot≥−2 dB) , then T_{search}=N*3*Tᵣₛ ms. N=8 when the target cell is in the frequency range 2. T_{margin} is time for SSB post-processing. In some aspects, T_{margin} may be up to 2 ms. TΔ is for fine time tracking and acquiring full timing information of the candidate cell. TΔ=Tᵣₛ for both known and unknown target candidate cell, and Tᵣₛ is an SSB measurement time configuration periodicity of the candidate cell.

In some aspects, the value of X may be based at least in part on whether a RACH occasion is available. For example, the value may include a time until a first available RACH occasion in the candidate cell. In some aspects, T_{IU} is an interruption uncertainty in acquiring the first available PRACH occasion in the candidate cell.

In some aspects, the value of X may be based at least in part on an RF tuning time (T_{RF-tuning}) from the serving cell to the candidate cell. This may be a component of the value of X if a bandwidth, subcarrier spacing (SCS), and/or center frequency is different from the serving cell and the candidate cell.

In some aspects, the value of X may be based at least in part on RRC processing time (T_{RRC-proc}) for PRACH configurations in the candidate cell. This may be a component of the value of X if a PRACH configuration in the candidate cell is used for the PRACH communication when the UE does not in advance process the PRACH configuration.

In some aspects, the value of X may be based at least in part on radio frequency (RF) preparation time (Tₚᵣₑₚₐᵣₑ) for PRACH configurations in the candidate cell. For example, for PRACH transmission on a candidate cell which is not configured with PUCCH and/or PUSCH, the UE may generate and store a separate RF configuration for each such candidate cell, so that the UE can change RF configuration from a serving cell to the candidate cell for PRACH transmission. The RF configuration may include the transmit filter to satisfy the corresponding carrier aggregation or component carrier emission mask requirement. The UE may report a UE capability of Tₚᵣₑₚₐᵣₑ time for the time gap between the PDCCH order and the PRACH for RF preparation in a candidate cell. The corresponding candidate value for the UE capability may at least include 0 and 7 ms with the non-zero value accommodating the time of RF configuration preparation in the case that the UE does not in advance generate or store the corresponding RF configuration for PRACH transmission in a candidate cell. For example, for PDCCH-order based PRACH on a candidate cell that is not a serving cell configured with PUCCH/PUSCH, the time gap between the PDCCH order and PRACH may be at least T=N_{T,2}+Δ_{BWPSwitching}+Δ_{Delay}+T_{switch}+Tₚᵣₑₚₐᵣₑ msec, where N_{T,2} is a time duration of N₂ symbols corresponding to a PUSCH preparation time, Δ_{BWPSwitching} is the time duration for changing the active UL BWP, Δ_{Delay}=0.5 msec for frequency rang 1 or Δ_{Delay}=0.25 msec for frequency rang 2, and T_{switch} is a transmission chain switching gap duration.

In some aspects, the value of X is a combination of a Tᵢₙₜₑᵣᵣᵤₚₜ, a T_{RRC-proc}, a T_{IU}, Tₚᵣₑₚₐᵣₑ and/or a T_{RF-tuning}.

In some aspects, the UE may prioritize the PRACH transmission in a candidate cell if the PRACH transmission overlaps in time with an uplink transmission on any of the interrupted serving cells. For example, the UE may drop uplink transmission on any of the interrupted serving cells for at least a time window including the PRACH transmission, and the required switching time before and after the PRACH transmission.

In some aspects, the UE may be configured or scheduled (e.g., via a configuration of a periodic communication or an indication of a dynamic scheduling communication) to transmit or receive a communication via the serving cell after being triggered to transmit the PRACH communication to the candidate cell. If the communication conflicts with the PRACH communication, the UE may always prioritize the PRACH communication in the candidate cell. Alternatively, the UE may prioritize the communication or the PRACH communication based at least in part on a communication type of the communication. For example, a downlink communication in the serving cell may be prioritized higher than the PRACH communication in the candidate cell, and an uplink communication in the serving cell may be prioritized lower than the PRACH communication in the candidate cell.

In some aspects, when a UE is to receive an RAR in the candidate cell associated with the PRACH communication to a candidate cell, the UE may start an RAR window from at a time that is Y1 symbols or slots after the PRACH communication. In some aspects, Y1 is a configured or fixed value (e.g., Y1=4 ms or 4 symbols). In some aspects, the UE may not expect to receive or transmit in the serving cell from the end of the PRACH communication until the start or the end of the RAR window.

In some aspects, Y1 includes at least the RF tuning time between the serving cell and the candidate cell (e.g., to the candidate cell and/or back to the serving cell). In some aspects, the UE may support reception or transmission in the serving cell after the PRACH transmission before or during the RAR window. If the UE supports communication in the serving cell after the PRACH transmission before or during the RAR window, the UE may always prioritize the RAR in the candidate cell. Alternatively, the UE may prioritize the communication or the RAR based at least in part on a communication type of the communication. For example, a downlink communication in the serving cell may be prioritized higher than the RAR in the candidate cell, and an uplink communication in the serving cell may be prioritized lower than the RAR in the candidate cell.

In some aspects, the UE may receive the RAR in the serving cell (e.g., in response to a PRACH communication to the candidate cell, which PRACH communication was triggered in the serving cell). In some aspects, the UE may start the RAR window at Y2 symbols or slots after the PRACH communication. In this case, Y2 may include at least an RF tuning time from the candidate cell to the serving cell.

FIG. 8 is a diagram of an example 800 associated with PRACH communications scheduled for a candidate cell, in accordance with the present disclosure. As shown in FIG. 8, a first network node and a second network node (e.g., network node 110, a CU, a DU, and/or an RU) may communicate with a UE (e.g., UE 120). In some aspects, the first network node, the second network node, and the UE may be part of a wireless network (e.g., wireless network 100). The UE and the first network node may have established a wireless connection prior to operations shown in FIG. 8.

As shown by reference number 805, the first network node may transmit, and the UE may receive, configuration information. In some aspects, the UE may receive the configuration information via one or more of RRC signaling, one or more MAC control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit a capability report that indicates whether the UE supports a transmitting PRACH communication to a candidate cell before receiving a cell switching command. In some aspects, the configuration information may indicate that the UE is to provide an indication of one or more parameters associated with transmitting a PRACH communication to a candidate cell before reception of the cell switching command.

The UE may configure itself based at least in part on the configuration information. In some aspects, the UE may be configured to perform one or more operations described herein based at least in part on the configuration information.

As shown by reference number 810, the UE may transmit, and the network node may receive, a capabilities report. In some aspects, the capabilities report may indicate UE support for transmitting a PRACH communication to a candidate cell before receiving a cell switching command. In some aspects, the capabilities report may indicate one or more capabilities of the UE associated with a duration of an offset between receiving an indication to transmit a PRACH communication and transmission of the PRACH communication, and/or a duration of an offset between transmitting the PRACH communication and receiving a response message associated with the PRACH communication. In some aspects, the capabilities report may indicate support for receiving the indication to transmit the PRACH communication to the candidate cell with the offset between receiving an indication to transmit a PRACH communication and transmission of the PRACH communication and/or the offset between transmitting the PRACH communication and receiving a response message associated with the PRACH communication.

As shown by reference number 815, the UE may receive, and the first network node may transmit, an indication to transmit a PRACH communication to a candidate cell. For example, the network node may transmit a PRACH order. In some aspects, the UE may communicate with the first network node via a serving cell, and the UE may receive the indication via the serving cell. In some aspects, the UE may receive the indication via a control channel of the serving cell, such as a PDCCH.

In some aspects, the indication to transmit the PRACH communication to the candidate cell may include one or more parameters to use for transmitting the PRACH communication. For example, the one or more parameters may include an indication of a preamble to use for the PRACH communication, a RACH occasion to use to transmit the PRACH communication, and/or synchronization information (e.g., coarse synchronization information) associated with the candidate cell, among other examples.

As shown by reference number 820, the UE may wait for a duration of an offset before transmitting the PRACH communication. In some aspects, the offset may be based at least in part on whether the UE previously identified the candidate cell, one or more characteristics of a RACH associated with the candidate cell, and/or one or more capabilities of the UE, among other examples. In some aspects, the one or more capabilities of the UE may include an RF tuning time of the UE to tune from the serving cell to the candidate cell and/or an RRC processing time for PRACH communications associated with the candidate cell, among other examples.

As shown by reference number 825, the UE may transmit, and the second network node may receive, the PRACH communication to the second network node via the candidate cell after the offset.

As shown by reference number 830, the UE may be scheduled for communication via the serving cell, which communication overlaps in time with the PRACH communication. In some aspects, the UE may transmit the PRACH communication and ignore communications via the serving cell that conflict (e.g., at least partially overlap in time) with the PRACH communication. In some aspects, the UE may communicate via the serving cell and cancel transmission of the PRACH communication if the communications via the serving cell conflict with the PRACH communication.

For example, the UE may prioritize the PRACH communication over a conflicting communication associated with the serving cell based at least in part on receiving the indication to transmit the PRACH communication. Alternatively, the UE may prioritize the PRACH communication over a conflicting communication associated with the serving cell based at least in part on a communication type of the conflicting communication. For example, the UE may prioritize downlink communications via the serving cell over the PRACH communication, and may prioritize the PRACH communication over an uplink communication via the serving cell.

In some aspects, the UE and/or the first network node may be configured not to communicate via the serving cell during a response window associated with receiving the response message. In some aspects, the UE and/or the first network node may be configured not to communicate via the serving cell during a duration from transmission of the PRACH communication until a start or an end of a response window associated with the response message.

Alternatively, the UE may support communication via the serving cell after transmission of the PRACH communication until a start or an end of a response window associated with the response message. In this case, the UE may prioritize the PRACH communication, the RAR, and/or communications via the serving cell. For example, the UE may prioritize the response message over a conflicting communication associated with the serving cell based at least in part on transmitting the PRACH communication. Additionally, or alternatively, the UE may prioritize the PRACH communication over a conflicting communication associated with the serving cell based at least in part on a communication type of the conflicting communication.

As shown by reference number 835, the UE may wait for a duration of an offset before receiving a response message associated with the PRACH communication. In some aspects, the offset may be based at least in part on a fixed duration and/or one or more capabilities of the UE. For example, the fixed duration may be based at least in part on one or more values indicated in a communication protocol, the candidate cell, and/or the serving cell, among other examples. In some aspects, the one or more capabilities of the UE may include an RF tuning time of the UE to tune from the serving cell to the candidate cell.

As shown by reference number 840, the UE may receive, and the first network node or the second network node may transmit, the response message after the offset. In some aspects, the UE may receive the response message within a response window that begins with an additional offset from transmission of the PRACH communication. The additional offset based at least in part on the one or more capabilities of the UE. For example, the additional offset may be based at least in part on an RF tuning time of the UE to tune from the candidate cell to the serving cell.

In some aspects where the UE receives the response message via the serving cell, the UE may receive the response message within a response window that begins with an additional offset from transmission of the PRACH communication, the additional offset based at least in part on one or more of an additional fixed duration or the one or more capabilities of the UE.

As shown by reference number 845, the UE may receive, and the first network node may transmit, a cell switching command. The cell switching command may indicate to switch from a serving cell to a candidate cell of the one or more candidate cells. In some aspects, the UE may receive the cell switching command after receiving the indication to transmit the PRACH communication to the candidate cell.

As shown by reference number 850, the UE and the second network node may exchange communications via the candidate cell after the cell switching command. In some aspects, the UE and the second network node may establish a wireless link that is based at least in part on the PRACH communication and/or the response message.

Based at least in part on the transmitting the PRACH communication associated with a candidate cell before receiving a cell switching command, the UE may reduce an amount of time of the cell switching during which communications are interrupted. In this way, UE may reduce communication errors, reduce or avoid skipping in a stream of data, and/or decrease a likelihood of a loss of an application layer connection based at least in part on reducing the amount of time of the cell switching.

As indicated above, FIG. 8 is provided as an example. Other examples may differ from what is described with respect to FIG. 8.

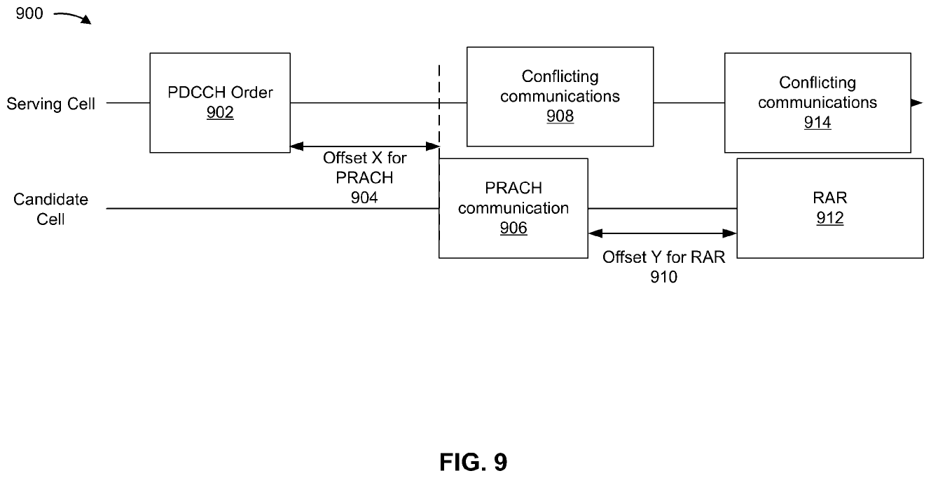

FIG. 9 is a diagram of an example 900 associated with receiving a PDCCH order to transmit a PRACH communication before cell switching, in accordance with the present disclosure. In context of FIG. 9, a first network node and a second network node (e.g., network node 110, a CU, a DU, and/or an RU) may communicate with a UE (e.g., UE 120) via a serving cell and a candidate cell. In some aspects, the first network node, the second network node, and the UE may be part of a wireless network (e.g., wireless network 100). The UE and the first network node may have established a wireless connection prior to operations shown in FIG. 9.

As shown in FIG. 9, the UE may receive a PDCCH order 902 within the serving cell. The PDCCH order 902 may indicate to transmit a PRACH communication before a cell switching command. In some aspects, the PDCCH order 902 may indicate one or more parameters for transmitting the PRACH communication, such as a RACH occasion to use, a preamble to use for the PRACH communication, and/or synchronization information associated with the candidate cell, among other examples.

The UE may wait for an offset X for the PRACH 904 before transmitting the PRACH communication 906. The PRACH communication 906 may include a msg1 or a msgA, as described in FIGS. 6 and 7, respectively.

In some aspects, the UE may be scheduled with one or more conflicting communications 908 in the serving cell. In some aspects, the UE may prioritize the PRACH communication 906 or the conflicting communications 908 based at least in part on a configuration and/or a communication type of the conflicting communications, among other examples.

The UE may wait for an offset Y for RAR 910 before attempting to receive an RAR 912 associated with the RACH communication. In some aspects, the UE may be scheduled with one or more conflicting communications 914 via the serving cell. Similar to the conflicting communications 908, the UE may prioritize the RAR 912 or the conflicting communications 914 based at least in part on a configuration and/or a communication type of the conflicting communications, among other examples.

As indicated above, FIG. 9 is provided as an example. Other examples may differ from what is described with respect to FIG. 9.

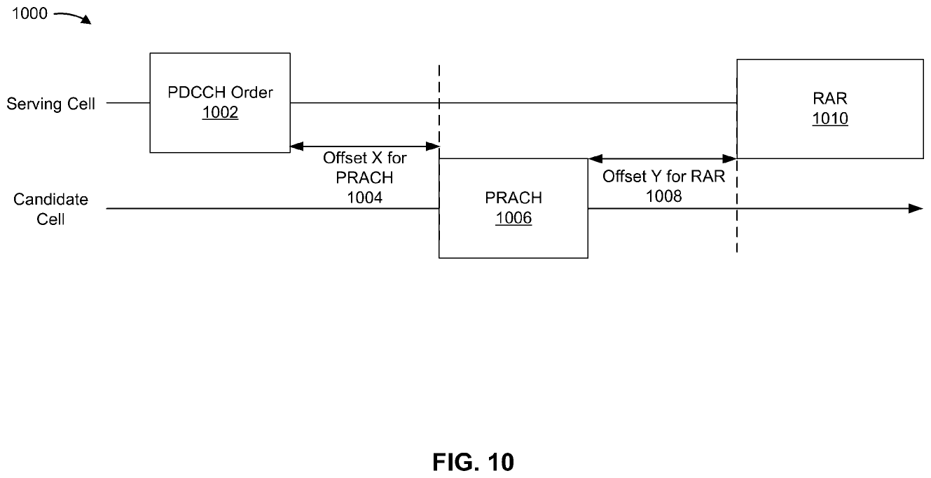

FIG. 10 is a diagram of an example 1000 associated with receiving a PDCCH order to transmit a PRACH communication before cell switching, in accordance with the present disclosure. In context of FIG. 10, a first network node and a second network node (e.g., network node 110, a CU, a DU, and/or an RU) may communicate with a UE (e.g., UE 120) via a serving cell and a candidate cell. In some aspects, the first network node, the second network node, and the UE may be part of a wireless network (e.g., wireless network 100). The UE and the first network node may have established a wireless connection prior to operations shown in FIG. 10.

As shown in FIG. 10, the UE may receive a PDCCH order 1002 within the serving cell. The PDCCH order 1002 may indicate to transmit a PRACH communication before a cell switching command. In some aspects, the PDCCH order 1002 may indicate one or more parameters for transmitting the PRACH communication, such as a RACH occasion to use, a preamble to use for the PRACH communication, and/or synchronization information associated with the candidate cell, among other examples.

The UE may wait for an offset X for the PRACH 1004 before transmitting the PRACH communication 1006. The PRACH communication 1006 may include a msg1 or a msgA, as described in FIGS. 6 and 7, respectively.

The UE may wait for an offset Y for RAR 1008 before attempting to receive an RAR 1010 via the serving cell during an RAR window that begins after the offset Y. Based at least in part on receiving the RAR 1010 via the serving cell, the offset Y may include time for RF tuning back to the serving cell.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with PRACH communications scheduled for a candidate cell.

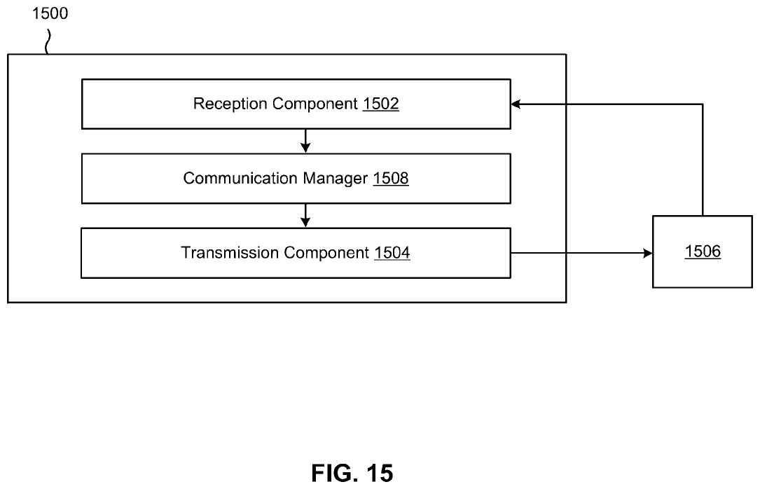

As shown in FIG. 11, in some aspects, process 1100 may include receiving, via a serving cell, an indication to transmit a PRACH communication to a candidate cell (block 1110). For example, the UE (e.g., using reception component 1502 and/or communication manager 1506, depicted in FIG. 15) may receive, via a serving cell, an indication to transmit a PRACH communication to a candidate cell, as described above.

As further shown in FIG. 11, in some aspects, process 1100 may include transmitting the PRACH communication with an offset from reception of the indication to transmit the PRACH communication, the offset based at least in part on one or more of: whether the UE previously identified the candidate cell, one or more characteristics of a RACH associated with the candidate cell, or one or more capabilities of the UE (block 1120). For example, the UE (e.g., using transmission component 1504 and/or communication manager 1506, depicted in FIG. 15) may transmit the PRACH communication with an offset from reception of the indication to transmit the PRACH communication, the offset based at least in part on one or more of: whether the UE previously identified the candidate cell, one or more characteristics of a RACH associated with the candidate cell, or one or more capabilities of the UE, as described above.

Process 1100 may include additional aspects, such as any single aspect or any combination of aspects described below and/or in connection with one or more other processes described elsewhere herein.

In a first aspect, receiving the indication to transmit the PRACH communication to the candidate cell comprises receiving the indication via a control channel.

In a second aspect, alone or in combination with the first aspect, the indication to transmit the PRACH communication to the candidate cell comprises an indication of one or more of a preamble to use for the PRACH communication, or a RACH occasion to use to transmit the PRACH communication, the RACH occasion having the offset from receiving the indication to transmit the PRACH communication.

In a third aspect, alone or in combination with one or more of the first and second aspects, transmitting the PRACH communication with the offset from receiving the indication to transmit the PRACH communication comprises one or more of prioritizing the PRACH communication over a conflicting communication associated with the serving cell based at least in part on receiving the indication to transmit the PRACH communication, or prioritizing the PRACH communication over a conflicting communication associated with the serving cell based at least in part on a communication type of the conflicting communication.

In a fourth aspect, alone or in combination with one or more of the first through third aspects, the one or more characteristics of the RACH associated with the candidate cell comprises whether a subsequent RACH occasion is available.

In a fifth aspect, alone or in combination with one or more of the first through fourth aspects, the one or more capabilities of the UE comprise one or more of a radio frequency tuning time of the UE to tune from the serving cell to the candidate cell, or a RRC processing time for PRACH configurations associated with the candidate cell.

In a sixth aspect, alone or in combination with one or more of the first through fifth aspects, process 1100 includes transmitting an indication of one or more capabilities associated with the offset.

In a seventh aspect, alone or in combination with one or more of the first through sixth aspects, process 1100 includes transmitting an indication of support for receiving the indication to transmit the PRACH communication to the candidate cell with the offset.

In an eighth aspect, alone or in combination with one or more of the first through seventh aspects, process 1100 includes receiving, via the serving cell, a response message associated with the PRACH communication.

In a ninth aspect, alone or in combination with one or more of the first through eighth aspects, receiving the response message comprises receiving the response message within a response window that begins with an additional offset from transmission of the PRACH communication, the additional offset based at least in part on the one or more capabilities of the UE.

In a tenth aspect, alone or in combination with one or more of the first through ninth aspects, the one or more capabilities of the UE is based at least in part on a radio frequency tuning time of the UE to tune from the candidate cell to the serving cell.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with PRACH communications scheduled for a candidate cell.

As shown in FIG. 12, in some aspects, process 1200 may include transmitting a PRACH communication to a candidate cell based at least in part on reception of an indication to transmit the PRACH communication from a serving cell (block 1210). For example, the UE (e.g., using transmission component 1504 and/or communication manager 1506, depicted in FIG. 15) may transmit a PRACH communication to a candidate cell based at least in part on reception of an indication to transmit the PRACH communication from a serving cell, as described above.

As further shown in FIG. 12, in some aspects, process 1200 may include receiving a response message, associated with the PRACH communication, with an offset from transmission of the PRACH communication, the offset based at least in part on one or more of: a fixed duration, or one or more capabilities of the UE (block 1220). For example, the UE (e.g., using reception component 1502 and/or communication manager 1506, depicted in FIG. 15) may receive a response message, associated with the PRACH communication, with an offset from transmission of the PRACH communication, the offset based at least in part on one or more of: a fixed duration, or one or more capabilities of the UE, as described above.

Process 1200 may include additional aspects, such as any single aspect or any combination of aspects described below and/or in connection with one or more other processes described elsewhere herein.

In a first aspect, receiving the response message comprises receiving the response message via the candidate cell.

In a second aspect, alone or in combination with the first aspect, the fixed duration is based at least in part on one or more of a value indicated in a communication protocol, a value associated with the candidate cell, or a value associated with the serving cell.

In a third aspect, alone or in combination with one or more of the first and second aspects, the one or more capabilities of the UE are based at least in part on a radio frequency tuning time of the UE to tune from the serving cell to the candidate cell.

In a fourth aspect, alone or in combination with one or more of the first through third aspects, the UE is configured not to communicate via the serving cell during one or more of a response window associated with receiving the response message, or a duration from transmission of the PRACH communication until a start or an end of a response window associated with the response message.

In a fifth aspect, alone or in combination with one or more of the first through fourth aspects, the UE supports communication via the serving cell after transmission of the PRACH communication until a start or an end of a response window associated with the response message.

In a sixth aspect, alone or in combination with one or more of the first through fifth aspects, receiving the response message comprises prioritizing the response message over a conflicting communication associated with the serving cell based at least in part on transmitting the PRACH communication, or prioritizing the PRACH communication over a conflicting communication associated with the serving cell based at least in part on a communication type of the conflicting communication.

In a seventh aspect, alone or in combination with one or more of the first through sixth aspects, receiving the response message comprises receiving the response message via the serving cell.

In an eighth aspect, alone or in combination with one or more of the first through seventh aspects, receiving the response message comprises receiving the response message within a response window that begins with an additional offset from transmission of the PRACH communication, the additional offset based at least in part on one or more of an additional fixed duration or the one or more capabilities of the UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with PRACH communications scheduled for a candidate cell.

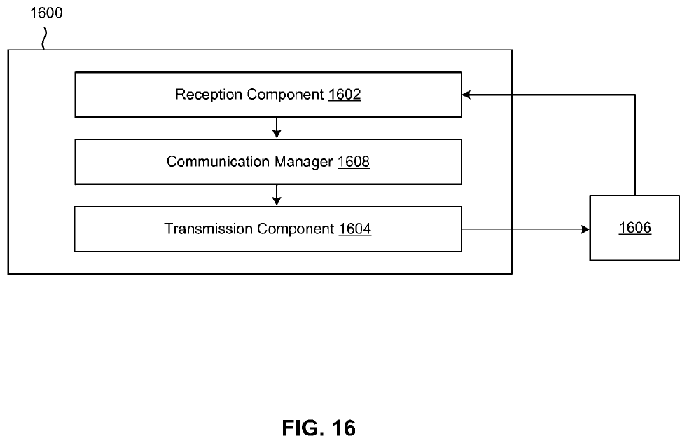

As shown in FIG. 13, in some aspects, process 1300 may include transmitting, via a serving cell and to a UE, an indication to transmit a PRACH communication to a candidate cell (block 1310). For example, the network node (e.g., using transmission component 1604 and/or communication manager 1606, depicted in FIG. 16) may transmit, via a serving cell and to a UE, an indication to transmit a PRACH communication to a candidate cell, as described above.

As further shown in FIG. 13, in some aspects, process 1300 may include receiving the PRACH communication with an offset from transmission of the indication to transmit the PRACH communication, the offset based at least in part on one or more of: whether the UE previously identified the candidate cell, one or more characteristics of a RACH associated with the candidate cell, or one or more capabilities of the UE (block 1320). For example, the network node (e.g., using reception component 1602 and/or communication manager 1606, depicted in FIG. 16) may receive the PRACH communication with an offset from transmission of the indication to transmit the PRACH communication, the offset based at least in part on one or more of: whether the UE previously identified the candidate cell, one or more characteristics of a RACH associated with the candidate cell, or one or more capabilities of the UE, as described above.

Process 1300 may include additional aspects, such as any single aspect or any combination of aspects described below and/or in connection with one or more other processes described elsewhere herein.

In a first aspect, transmitting the indication to transmit the PRACH communication to the candidate cell comprises transmitting the indication via a control channel.

In a second aspect, alone or in combination with the first aspect, the indication to transmit the PRACH communication to the candidate cell comprises an indication of one or more of a preamble to use for the PRACH communication, or a RACH occasion to use to transmit the PRACH communication, the RACH occasion having the offset from receiving the indication to transmit the PRACH communication.

In a third aspect, alone or in combination with one or more of the first and second aspects, receiving the PRACH communication with the offset from transmitting the indication to transmit the PRACH communication is based at least in part on one or more of a configuration of the UE to prioritize the PRACH communication over a conflicting communication associated with the serving cell based at least in part on receiving the indication to transmit the PRACH communication, or a configuration of the UE to prioritize the PRACH communication over a conflicting communication associated with the serving cell based at least in part on a communication type of the conflicting communication.

In a fourth aspect, alone or in combination with one or more of the first through third aspects, the one or more characteristics of the RACH associated with the candidate cell comprises whether a subsequent RACH occasion is available.

In a fifth aspect, alone or in combination with one or more of the first through fourth aspects, the one or more capabilities of the UE comprise one or more of a radio frequency tuning time of the UE to tune from the serving cell to the candidate cell, or a RRC processing time for PRACH configurations associated with the candidate cell.

In a sixth aspect, alone or in combination with one or more of the first through fifth aspects, process 1300 includes receiving an indication of one or more capabilities associated with the offset.

In a seventh aspect, alone or in combination with one or more of the first through sixth aspects, process 1300 includes receiving an indication of support for the UE to receive the indication to transmit the PRACH communication to the candidate cell with the offset.

In an eighth aspect, alone or in combination with one or more of the first through seventh aspects, process 1300 includes transmitting a response message associated with the PRACH communication.

In a ninth aspect, alone or in combination with one or more of the first through eighth aspects, transmitting the response message comprises transmitting the response message within a response window that begins with an additional offset from reception of the PRACH communication, the additional offset based at least in part on the one or more capabilities of the UE.

In a tenth aspect, alone or in combination with one or more of the first through ninth aspects, the one or more capabilities of the UE is based at least in part on a radio frequency tuning time of the UE to tune from the candidate cell to the serving cell.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with PRACH communications scheduled for a candidate cell.

As shown in FIG. 14, in some aspects, process 1400 may include receiving a PRACH communication, from a UE and via a candidate cell, based at least in part on transmission of an indication to transmit the PRACH communication from a serving cell (block 1410). For example, the network node (e.g., using reception component 1602 and/or communication manager 1606, depicted in FIG. 16) may receive a PRACH communication, from a UE and via a candidate cell, based at least in part on transmission of an indication to transmit the PRACH communication from a serving cell, as described above.

As further shown in FIG. 14, in some aspects, process 1400 may include transmitting a response message, associated with the PRACH communication, with an offset from transmission of the PRACH communication, the offset based at least in part on one or more of: a fixed duration, or one or more capabilities of the UE (block 1420). For example, the network node (e.g., using transmission component 1604 and/or communication manager 1606, depicted in FIG. 16) may transmit a response message, associated with the PRACH communication, with an offset from transmission of the PRACH communication, the offset based at least in part on one or more of: a fixed duration, or one or more capabilities of the UE, as described above.

Process 1400 may include additional aspects, such as any single aspect or any combination of aspects described below and/or in connection with one or more other processes described elsewhere herein.

In a first aspect, transmitting the response message comprises transmitting the response message via the candidate cell.

In a second aspect, alone or in combination with the first aspect, the fixed duration is based at least in part on one or more of a value indicated in a communication protocol, a value associated with the candidate cell, or a value associated with the serving cell.

In a third aspect, alone or in combination with one or more of the first and second aspects, the one or more capabilities of the UE are based at least in part on a radio frequency tuning time of the UE to tune from the serving cell to the candidate cell.

In a fourth aspect, alone or in combination with one or more of the first through third aspects, the UE is configured not to communicate via the serving cell during one or more of a response window associated with receiving the response message, or a duration from transmission of the PRACH communication until a start or an end of a response window associated with the response message.

In a fifth aspect, alone or in combination with one or more of the first through fourth aspects, the UE is configured to support communication via the serving cell after transmission of the PRACH communication until a start or an end of a response window associated with the response message.

In a sixth aspect, alone or in combination with one or more of the first through fifth aspects, process 1400 includes prioritizing the response message over a conflicting communication associated with the serving cell based at least in part on receiving the PRACH communication, or prioritizing the PRACH communication over a conflicting communication associated with the serving cell based at least in part on a communication type of the conflicting communication.

In a seventh aspect, alone or in combination with one or more of the first through sixth aspects, transmitting the response message comprises transmitting the response message via the serving cell.

In an eighth aspect, alone or in combination with one or more of the first through seventh aspects, receiving the response message comprises transmitting the response message within a response window that begins with an additional offset from reception of the PRACH communication, the additional offset based at least in part on one or more of an additional fixed duration or the one or more capabilities of the UE.

In a ninth aspect, alone or in combination with one or more of the first through eighth aspects, the network node is associated with the serving cell and the candidate cell, a first additional network node provides the serving cell, and a second additional network node provides the candidate cell.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 8-10. Additionally, or alternatively, the apparatus 1500 may be configured to perform one or more processes described herein, such as process 1100 of FIG. 11, process 1200 of FIG. 12, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive, via a serving cell, an indication to transmit a PRACH communication to a candidate cell. The transmission component 1504 may transmit the PRACH communication with an offset from reception of the indication to transmit the PRACH communication, the offset based at least in part on one or more of whether the UE previously identified the candidate cell, one or more characteristics of a RACH associated with the candidate cell, or one or more capabilities of the UE.

The transmission component 1504 may transmit an indication of one or more capabilities associated with the offset.

The transmission component 1504 may transmit an indication of support for receiving the indication to transmit the PRACH communication to the candidate cell with the offset.

The reception component 1502 may receive, via the serving cell, a response message associated with the PRACH communication.

The transmission component 1504 may transmit a PRACH communication to a candidate cell based at least in part on reception of an indication to transmit the PRACH communication from a serving cell. The reception component 1502 may receive a response message, associated with the PRACH communication, with an offset from transmission of the PRACH communication, the offset based at least in part on one or more of a fixed duration, or one or more capabilities of the UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 8-10. Additionally, or alternatively, the apparatus 1600 may be configured to perform one or more processes described herein, such as process 1300 of FIG. 13, process 1400 of FIG. 14, or a combination thereof. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may transmit, via a serving cell and to a UE, an indication to transmit a PRACH communication to a candidate cell. The reception component 1602 may receive the PRACH communication with an offset from transmission of the indication to transmit the PRACH communication, the offset based at least in part on one or more of whether the UE previously identified the candidate cell, one or more characteristics of a RACH associated with the candidate cell, or one or more capabilities of the UE.

The reception component 1602 may receive an indication of one or more capabilities associated with the offset.

The reception component 1602 may receive an indication of support for the UE to receive the indication to transmit the PRACH communication to the candidate cell with the offset.

The transmission component 1604 may transmit a response message associated with the PRACH communication.

The reception component 1602 may receive a PRACH communication, from a UE and via a candidate cell, based at least in part on transmission of an indication to transmit the PRACH communication from a serving cell. The transmission component 1604 may transmit a response message, associated with the PRACH communication, with an offset from transmission of the PRACH communication, the offset based at least in part on one or more of a fixed duration, or one or more capabilities of the UE.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving, via a serving cell, an indication to transmit a physical random access channel (PRACH) communication to a candidate cell; and transmitting the PRACH communication with an offset from reception of the indication to transmit the PRACH communication, the offset based at least in part on one or more of: whether the UE previously identified the candidate cell, one or more characteristics of a random access channel (RACH) associated with the candidate cell, or one or more capabilities of the UE.

Aspect 2: The method of Aspect 1, wherein receiving the indication to transmit the PRACH communication to the candidate cell comprises: receiving the indication via a control channel.

Aspect 3: The method of any of Aspects 1-2, wherein the indication to transmit the PRACH communication to the candidate cell comprises an indication of one or more of: a preamble to use for the PRACH communication, or a RACH occasion to use to transmit the PRACH communication, the RACH occasion having the offset from receiving the indication to transmit the PRACH communication.

Aspect 4: The method of any of Aspects 1-3, wherein transmitting the PRACH communication with the offset from receiving the indication to transmit the PRACH communication comprises one or more of: prioritizing the PRACH communication over a conflicting communication associated with the serving cell based at least in part on receiving the indication to transmit the PRACH communication, or prioritizing the PRACH communication over a conflicting communication associated with the serving cell based at least in part on a communication type of the conflicting communication.

Aspect 5: The method of any of Aspects 1-4, wherein the one or more characteristics of the RACH associated with the candidate cell comprises whether a subsequent random access channel (RACH) occasion is available.

Aspect 6: The method of any of Aspects 1-5, wherein the one or more capabilities of the UE comprise one or more of: a radio frequency tuning time of the UE to tune from the serving cell to the candidate cell, or a radio resource control (RRC) processing time for PRACH configurations associated with the candidate cell.

Aspect 7: The method of any of Aspects 1-6, further comprising: transmitting an indication of one or more capabilities associated with the offset.

Aspect 8: The method of any of Aspects 1-7, further comprising: transmitting an indication of support for receiving the indication to transmit the PRACH communication to the candidate cell with the offset.

Aspect 9: The method of any of Aspects 1-8, further comprising: receiving, via the serving cell, a response message associated with the PRACH communication.

Aspect 10: The method of Aspect 9, wherein receiving the response message comprises: receiving the response message within a response window that begins with an additional offset from transmission of the PRACH communication, the additional offset based at least in part on the one or more capabilities of the UE.

Aspect 11: The method of Aspect 10, wherein the one or more capabilities of the UE is based at least in part on a radio frequency tuning time of the UE to tune from the candidate cell to the serving cell.

Aspect 12: A method of wireless communication performed by a user equipment (UE), comprising: transmitting a physical random access channel (PRACH) communication to a candidate cell based at least in part on reception of an indication to transmit the PRACH communication from a serving cell; and receiving a response message, associated with the PRACH communication, with an offset from transmission of the PRACH communication, the offset based at least in part on one or more of: a fixed duration, or one or more capabilities of the UE.

Aspect 13: The method of Aspect 12, wherein receiving the response message comprises: receiving the response message via the candidate cell.

Aspect 14: The method of Aspect 13, wherein the fixed duration is based at least in part on one or more of: a value indicated in a communication protocol, a value associated with the candidate cell, or a value associated with the serving cell.

Aspect 15: The method of Aspect 13, wherein the one or more capabilities of the UE are based at least in part on a radio frequency tuning time of the UE to tune from the serving cell to the candidate cell.

Aspect 16: The method of Aspect 13, wherein the UE is configured not to communicate via the serving cell during one or more of: a response window associated with receiving the response message, or a duration from transmission of the PRACH communication until a start or an end of a response window associated with the response message.

Aspect 17: The method of Aspect 13, wherein the UE supports communication via the serving cell after transmission of the PRACH communication until a start or an end of a response window associated with the response message.

Aspect 18: The method of Aspect 17, wherein receiving the response message comprises: prioritizing the response message over a conflicting communication associated with the serving cell based at least in part on transmitting the PRACH communication, or prioritizing the PRACH communication over a conflicting communication associated with the serving cell based at least in part on a communication type of the conflicting communication.

Aspect 19: The method of any of Aspects 12-18, wherein receiving the response message comprises: receiving the response message via the serving cell.

Aspect 20: The method of Aspect 19, wherein receiving the response message comprises: receiving the response message within a response window that begins with an additional offset from transmission of the PRACH communication, the additional offset based at least in part on one or more of an additional fixed duration or the one or more capabilities of the UE.

Aspect 21: A method of wireless communication performed by a network node, comprising: transmitting, via a serving cell and to a user equipment (UE), an indication to transmit a physical random access channel (PRACH) communication to a candidate cell; and receiving the PRACH communication with an offset from transmission of the indication to transmit the PRACH communication, the offset based at least in part on one or more of: whether the UE previously identified the candidate cell, one or more characteristics of a random access channel (RACH) associated with the candidate cell, or one or more capabilities of the UE.

Aspect 22: The method of Aspect 21, wherein transmitting the indication to transmit the PRACH communication to the candidate cell comprises: transmitting the indication via a control channel.

Aspect 23: The method of any of Aspects 21-22, wherein the indication to transmit the PRACH communication to the candidate cell comprises an indication of one or more of: a preamble to use for the PRACH communication, or a RACH occasion to use to transmit the PRACH communication, the RACH occasion having the offset from receiving the indication to transmit the PRACH communication.

Aspect 24: The method of any of Aspects 21-23, wherein receiving the PRACH communication with the offset from transmitting the indication to transmit the PRACH communication is based at least in part on one or more of: a configuration of the UE to prioritize the PRACH communication over a conflicting communication associated with the serving cell based at least in part on receiving the indication to transmit the PRACH communication, or a configuration of the UE to prioritize the PRACH communication over a conflicting communication associated with the serving cell based at least in part on a communication type of the conflicting communication.

Aspect 25: The method of any of Aspects 21-24, wherein the one or more characteristics of the RACH associated with the candidate cell comprises whether a subsequent RACH occasion is available.

Aspect 26: The method of any of Aspects 21-25, wherein the one or more capabilities of the UE comprise one or more of: a radio frequency tuning time of the UE to tune from the serving cell to the candidate cell, or a radio resource control (RRC) processing time for PRACH configurations associated with the candidate cell.

Aspect 27: The method of any of Aspects 21-26, further comprising: receiving an indication of one or more capabilities associated with the offset.

Aspect 28: The method of any of Aspects 21-27, further comprising: receiving an indication of support for the UE to receive the indication to transmit the PRACH communication to the candidate cell with the offset.

Aspect 29: The method of any of Aspects 21-28, further comprising: transmitting a response message associated with the PRACH communication.

Aspect 30: The method of Aspect 29, wherein transmitting the response message comprises: transmitting the response message within a response window that begins with an additional offset from reception of the PRACH communication, the additional offset based at least in part on the one or more capabilities of the UE.

Aspect 31: The method of Aspect 30, wherein the one or more capabilities of the UE is based at least in part on a radio frequency tuning time of the UE to tune from the candidate cell to the serving cell.

Aspect 32: A method of wireless communication performed by a network node, comprising: receiving a physical random access channel (PRACH) communication, from a user equipment (UE) and via a candidate cell, based at least in part on transmission of an indication to transmit the PRACH communication from a serving cell; and transmitting a response message, associated with the PRACH communication, with an offset from transmission of the PRACH communication, the offset based at least in part on one or more of: a fixed duration, or one or more capabilities of the UE.

Aspect 33: The method of Aspect 32, wherein transmitting the response message comprises: transmitting the response message via the candidate cell.

Aspect 34: The method of Aspect 33, wherein the fixed duration is based at least in part on one or more of: a value indicated in a communication protocol, a value associated with the candidate cell, or a value associated with the serving cell.

Aspect 35: The method of Aspect 33, wherein the one or more capabilities of the UE are based at least in part on a radio frequency tuning time of the UE to tune from the serving cell to the candidate cell.

Aspect 36: The method of Aspect 33, wherein the UE is configured not to communicate via the serving cell during one or more of: a response window associated with receiving the response message, or a duration from transmission of the PRACH communication until a start or an end of a response window associated with the response message.

Aspect 37: The method of Aspect 33, wherein the UE is configured to support communication via the serving cell after transmission of the PRACH communication until a start or an end of a response window associated with the response message.

Aspect 38: The method of Aspect 37, wherein the UE is configured to: prioritize the response message over a conflicting communication associated with the serving cell based at least in part on receiving the PRACH communication, or prioritize the PRACH communication over a conflicting communication associated with the serving cell based at least in part on a communication type of the conflicting communication.

Aspect 39: The method of any of Aspects 32-38, wherein transmitting the response message comprises: transmitting the response message via the serving cell.

Aspect 40: The method of Aspect 39, wherein receiving the response message comprises: transmitting the response message within a response window that begins with an additional offset from reception of the PRACH communication, the additional offset based at least in part on one or more of an additional fixed duration or the one or more capabilities of the UE.

Aspect 41: The method of any of Aspects 32-40, wherein the network node is associated with the serving cell and the candidate cell, wherein a first additional network node provides the serving cell, and wherein a second additional network node provides the candidate cell.

Aspect 42: An apparatus for wireless communication at a device, comprising a processor; memory coupled with the processor; and instructions stored in the memory and executable by the processor to cause the apparatus to perform the method of one or more of Aspects 1-41.

Aspect 43: A device for wireless communication, comprising a memory and one or more processors coupled to the memory, the one or more processors configured to perform the method of one or more of Aspects 1-41.

Aspect 44: An apparatus for wireless communication, comprising at least one means for performing the method of one or more of Aspects 1-41.

Aspect 45: A non-transitory computer-readable medium storing code for wireless communication, the code comprising instructions executable by a processor to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, via a serving cell, an indication to transmit a physical random access channel (PRACH) communication to a candidate cell; and
transmit the PRACH communication with an offset from reception of the indication to transmit the PRACH communication, the offset based at least in part on one or more of:
whether the UE previously identified the candidate cell,
one or more characteristics of a random access channel (RACH) associated with the candidate cell, or
one or more capabilities of the UE.

2. The UE of claim 1, wherein the one or more processors, to receive the indication to transmit the PRACH communication to the candidate cell, are configured to:
receive the indication via a control channel.

3. The UE of claim 1, wherein the indication to transmit the PRACH communication to the candidate cell comprises an indication of one or more of:
a preamble to use for the PRACH communication, or
a random access channel (RACH) occasion to use to transmit the PRACH communication, the RACH occasion having the offset from receiving the indication to transmit the PRACH communication.

4. The UE of claim 1, wherein the one or more processors, to transmit the PRACH communication with the offset from receiving the indication to transmit the PRACH communication, are configured to:
prioritize the PRACH communication over a conflicting communication associated with the serving cell based at least in part on receiving the indication to transmit the PRACH communication, or
prioritize the PRACH communication over a conflicting communication associated with the serving cell based at least in part on a communication type of the conflicting communication.

5. The UE of claim 1, wherein the one or more characteristics of the RACH associated with the candidate cell comprises whether a subsequent random access channel (RACH) occasion is available.

6. The UE of claim 1, wherein the one or more capabilities of the UE comprise one or more of:
a radio frequency tuning time of the UE to tune from the serving cell to the candidate cell, or
a radio resource control (RRC) processing time for PRACH configurations associated with the candidate cell.

7. The UE of claim 1, wherein the one or more processors are further configured to:
transmit an indication of one or more capabilities associated with the offset.

8. The UE of claim 1, wherein the one or more processors are further configured to:
transmit an indication of support for receiving the indication to transmit the PRACH communication to the candidate cell with the offset.

9. The UE of claim 1, wherein the one or more processors are further configured to:
receive, via the serving cell, a response message associated with the PRACH communication.

10. The UE of claim 9, wherein the one or more processors, to receive the response message, are configured to:
receive the response message within a response window that begins with an additional offset from transmission of the PRACH communication, the additional offset based at least in part on the one or more capabilities of the UE.

11. The UE of claim 10, wherein the one or more capabilities of the UE is based at least in part on a radio frequency tuning time of the UE to tune from the candidate cell to the serving cell.

12. A user equipment (UE) for wireless communication, comprising:
a memory; and
one or more processors, coupled to the memory, configured to:
transmit a physical random access channel (PRACH) communication to a candidate cell based at least in part on reception of an indication to transmit the PRACH communication from a serving cell; and
receive a response message, associated with the PRACH communication, with an offset from transmission of the PRACH communication, the offset based at least in part on one or more of:
a fixed duration, or
one or more capabilities of the UE.

13. The UE of claim 12, wherein the one or more processors, to receive the response message, are configured to:
receive the response message via the candidate cell.

14. The UE of claim 12, wherein the fixed duration is based at least in part on one or more of:
a value indicated in a communication protocol,
a value associated with the candidate cell, or
a value associated with the serving cell.

15. The UE of claim 12, wherein the one or more capabilities of the UE are based at least in part on a radio frequency tuning time of the UE to tune from the serving cell to the candidate cell.

16. The UE of claim 12, wherein the UE is configured not to communicate via the serving cell during one or more of:
a response window associated with receiving the response message, or
a duration from transmission of the PRACH communication until a start or an end of a response window associated with the response message.

17. The UE of claim 12, wherein the UE supports communication via the serving cell after transmission of the PRACH communication until a start or an end of a response window associated with the response message.

18. (canceled)

19. The UE of claim 12, wherein the one or more processors, to receive the response message, are configured to:
receive the response message via the serving cell.

20. (canceled)

21. A network node for wireless communication, comprising:
a memory; and
one or more processors, coupled to the memory, configured to:
transmit, via a serving cell and to a user equipment (UE), an indication to transmit a physical random access channel (PRACH) communication to a candidate cell; and
receive the PRACH communication with an offset from transmission of the indication to transmit the PRACH communication, the offset based at least in part on one or more of:
whether the UE previously identified the candidate cell,
one or more characteristics of a random access channel (RACH) associated with the candidate cell, or
one or more capabilities of the UE.

22. The network node of claim 21, wherein the one or more processors, to transmit the indication to transmit the PRACH communication to the candidate cell, are configured to:
transmit the indication via a control channel.

23-30. (canceled)
